(19) United States
(12) Patent Application Publication
(10) Pub. No.: US 2017/0276970 A1
(43) Pub. Date: Sep. 28, 2017

(54) LIGHT MODULATOR

(71) Applicant: CENTERA Photonics Inc., Hsinchu (TW)

(72) Inventors: Chao-Hsuan CHUANG, Hsinchu County (TW); Chien-Chen HSIEH, Hsinchu (TW)

(21) Appl. No.: 15/451,422

(22) Filed: Mar. 7, 2017

(30) Foreign Application Priority Data
Mar. 28, 2016 (TW) 105109703

(51) Int. Cl. G02F 1/025

(52) U.S. Cl. CPC G02F 1/025

(57) ABSTRACT

A light modulator includes a substrate, a first semiconductor structure, a second semiconductor structure and a dielectric structure. The substrate has a principal surface and a first direction substantially perpendicular to the principal surface. The first semiconductor structure has a first conductive type and disposed over the principal surface. The second semiconductor structure has a second conductive type and disposed over the principal surface, in which the second semiconductor structure is free from overlapping the first semiconductor structure in the first direction. The dielectric structure is disposed over the principal surface and extends upwards from the principal surface such that dielectric structure is interposed between the first semiconductor structure and the second semiconductor structure.

### RELATED APPLICATIONS

This application claims priority to Taiwan Application Serial Number 105109703, filed Mar. 28, 2016, the entirety of which is incorporated herein by reference.

### BACKGROUND

Technical Field

The present disclosure relates to a light modulator. More particularly, the present disclosure relates to a light modulator with a horizontal configuration.

Description of Related Art

Optical modulators have been widely applied in a variety of optical fields. Optical modulators include a variety of types such as amplitude modulators, phase modulators, polarization modulators and the likes. The optical phase modulators may be used to control the phase of light. Typical optical phase modulators, for example, are electro-optical modulator devices such as Pockels cells or liquid crystal cell. A variety of optical phase modulators are used in integrated optical system (i.e., integrated optics). Light is transmitted in the waveguide structure of the integrated optical system, and the phase of light is controlled or modulated in the waveguide structure. In optical fiber communication systems, the optical phase modulators can be used to transmit coded messages. In addition, the optical modulators can also be applied in photonic chips.

### SUMMARY

According to one aspect of the present disclosure, a light modulator is provided. The light modulator includes a substrate, a first semiconductor structure, a second semiconductor structure, and a dielectric structure. The substrate has a principal surface and a first direction substantially perpendicular to the principal surface. The first semiconductor structure has a first conductive type and positioned over the principal surface. The second semiconductor structure has a second conductive type and positioned over the principal surface, in which the first semiconductor structure is free from overlapping the second semiconductor structure in the first direction. The dielectric structure is positioned over the principal surface and extends upwards along the first direction from the principal surface, and the dielectric structure is interposed between the first semiconductor structure and the second semiconductor structure. The first semiconductor structure, the second semiconductor structure, and the dielectric structure constitute an optical waveguide for providing a substantially elliptical or circular light channel.

In some embodiments of the present disclosure, the first semiconductor structure and the second semiconductor structure respectively have a first top surface and a second top surface, and the first top surface and the second top surface are covered by the dielectric structure.

In some embodiments of the present disclosure, the first top surface of the first semiconductor structure laterally extends on a substantially identical first level to a position touching the dielectric structure.

In some embodiments of the present disclosure, the second top surface of the second semiconductor structure extends on a substantially identical second level to a position touching the dielectric structure.

In sonic embodiments of the present disclosure, the first level is substantially the same as the second level.

In some embodiments of the present disclosure, the dielectric structure separates the first semiconductor structure from the second semiconductor structure such that the first semiconductor structure is not in direct contact with the second semiconductor structure.

In some embodiments of the present disclosure, the dielectric structure has a width and a height that is greater than the width.

In some embodiments of the present disclosure, the height of the dielectric structure is substantially equal to a thickness of the first semiconductor structure and a thickness of the second semiconductor structure.

In some embodiments of the present disclosure, a ratio of the height to the width of the dielectric structure is ranged from about 1.0 to about 50.0.

In some embodiments of the present disclosure, the first semiconductor structure and the second semiconductor structure respectively have a first width and a second width, and the first width is substantially equal to the second width.

In some embodiments of the present disclosure, the first semiconductor structure comprises a first doping portion and a second doping portion. The first doping portion is in contact with the dielectric structure and located between the dielectric structure and the second doping portion, and a doping concentration of the first doping portion is less than a doping concentration of the second doping portion.

In some embodiments of the present disclosure, a height of the first doping portion is greater than a height of the second doping portion.

In some embodiments of the present disclosure, the first doping portion comprises a standing portion and an extending portion, and the standing portion is in contact with the dielectric structure. The extending portion laterally extends from the standing portion to the second doping portion, and a height of the standing portion is greater than a height of the extending portion.

In some embodiments of the present disclosure, the height of the standing portion substantially equals a height of the dielectric structure, and the height of the extending portion substantially equals a height of the second doping portion.

In some embodiments of the present disclosure, the second semiconductor structure comprises a fourth doping portion and a fifth doping portion. The fourth doping portion is in contact with the dielectric structure and positioned between the dielectric structure and the fifth doping portion. A doping concentration of the fourth doping portion is less than a doping concentration of the fifth doping portion.

In some embodiments of the present disclosure, a height of the fourth doping portion is greater than a height of the fifth doping portion.

In some embodiments of the present disclosure, the fourth doping portion comprises a standing portion and an extending portion. The standing portion is in contact with the dielectric structure. The extending portion laterally extends from the standing portion to the fifth doping portion, and a height of the standing portion is greater than a height of the extending portion.

In some embodiments of the present disclosure, the height of the standing portion substantially equals a height of the dielectric structure, and the height of the extending portion substantially equals a height of the fifth doping portion.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view schematically illustrating a light modulator according to a comparative example of the present disclosure.

FIG. 2 is a diagram illustrating a simulation result of a light intensity distribution of a light modulator according to a comparative example of the present disclosure.

FIG. 3 is a perspective view schematically illustrating a light modulator according to various embodiments of the present disclosure.

FIG. 4 is a cross-sectional view schematically illustrating a light modulator according to some embodiments of the present disclosure.

### DESCRIPTION OF THE EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

It will be understood that, although the terms first, second, etc, may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees OT at other orientations) and the spatially relative descriptors used herein may likewise be interpreted accordingly.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

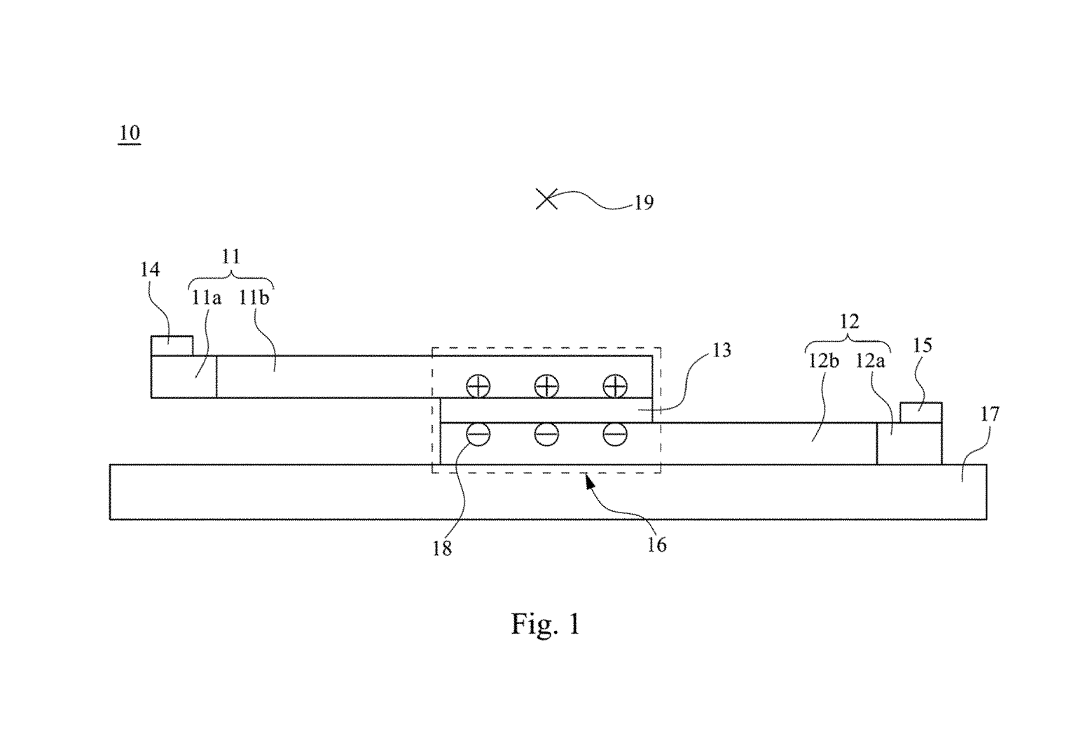

FIG. 1 is a cross-sectional view schematically illustrating a light modulator 10 according to a comparative example of the present disclosure. The light modulator 10 mainly includes a p-type polycrystalline silicon layer 11, an N-type polycrystalline silicon layer 12, an oxide layer 13, a conductive contact structure 14, a conductive contact structure 15 and a substrate 17. The p-type polycrystalline silicon layer 11 includes a P+ region 11a and a P region 11b. The N-type polycrystalline silicon layer 12 includes an N+ region 12a and an N region 12b. The conductive contact structure 14 and conductive contact structure 15 respectively contact the P+ region 11a and the N+ region 12a. The p-type polycrystalline silicon layer 11 is overlapped with a portion of the N-type polycrystalline silicon layer 12. The oxide layer 13 is interposed between the overlapped portions of the p-type polycrystalline silicon layer 11 and the N-type polycrystalline silicon layer 12. The overlapped regions of the p-type polycrystalline silicon layer 11, the oxide layer 13, and the N-type polycrystalline silicon layer 12 constitute an active region 16 of the light modulator 10. It is noted that the p-type polycrystalline silicon layer 11, the oxide layer 13, and the N-type polycrystalline silicon layer 12 in the active region 16 are configured to stack in a perpendicular direction to the substrate 17. Furthermore, the p-type polycrystalline silicon layer 11 and the N-type polycrystalline silicon layer have to be laterally extended for the purpose of disposing the conductive contact structures 14 and 15.

The oxide layer 13 may be understood or referred to as a “gate dielectric”. When an electrical potential difference is applied between the p-type polycrystalline silicon layer 11 and the N-type polycrystalline silicon layer 12, free carriers 18 gathers at the opposite sides of the oxide layer 13. When light transmits in the active region 16 along a direction 19 that is perpendicular to the illustrated paper sheet, the gathered free carriers 18 changes the phase of the light, thereby constituting the light modulator 10 capable of altering the phase of the light.

According to the operating principle of the light modulator 10 described above, the light transmitted therein is desirably to be concentrated or collected in the active region 16 in order to avoid the light escaping to the outside of the active region 16, and therefore the light modulator 10 may provide a relatively better performance.

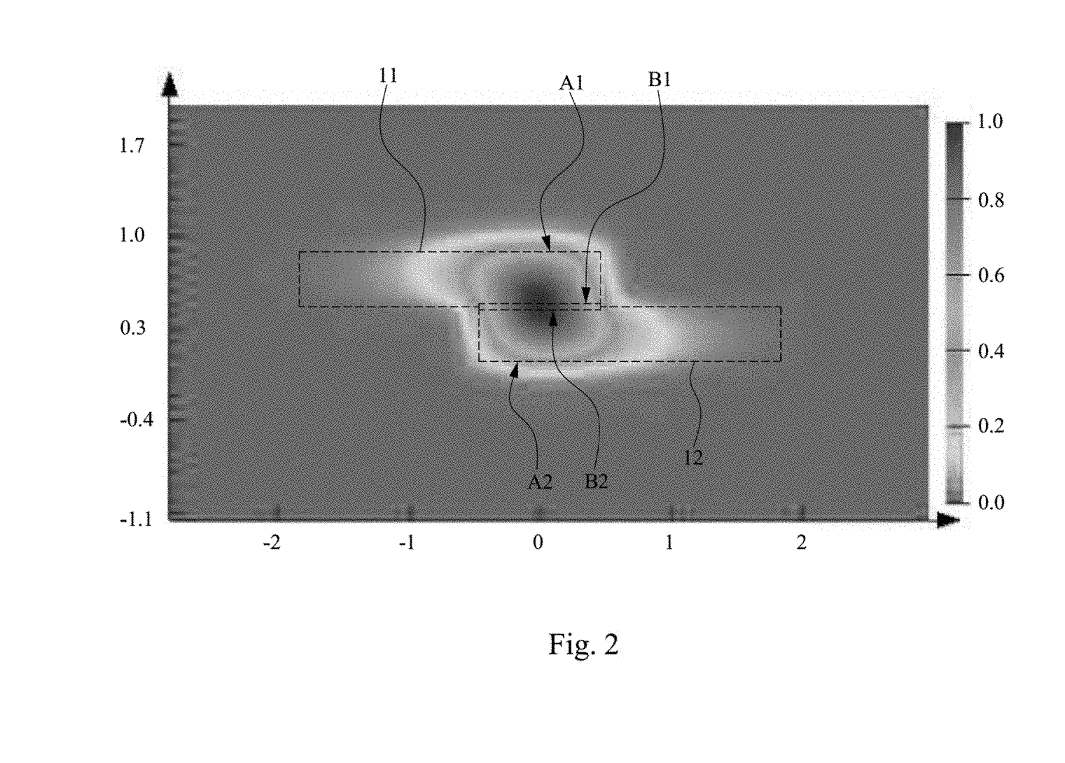

FIG. 2 is a diagram illustrating a simulation result of the light intensity distribution of the light modulator 10. In FIG. 2, it may be observed that light intensity distribution is deformed and distorted by the p-type polycrystalline silicon layer 11 and the N-type polycrystalline silicon layer 12. The light intensity distribution shows a laterally extension (or diffusion) along the p-type polycrystalline silicon layer 11 and the N-type polycrystalline silicon layer 12, resulting in that the light can not be completely concentrated in the active region.

In one aspect, it is desired to gather more free carriers at opposite sides of the oxide layer 13 in order to more effectively alter the phase of the light. In another aspect, however, it is not desired to have high doping concentrations at opposite sides of the oxide layer 13 because the dopants obstruct or hinder the light transmission. Therefore, there exists a trade-off there between.

Accordingly, the light modulator 10 has two technical drawbacks. One of the drawbacks is the light intensity distribution being distorted, resulting in that the light can not be effectively concentrated in the active region. The other one of the drawbacks is the dopant concentration at opposite sides of the oxide layer 13 is difficult to be controlled or modulated to reduce the hindrance to light transmission.

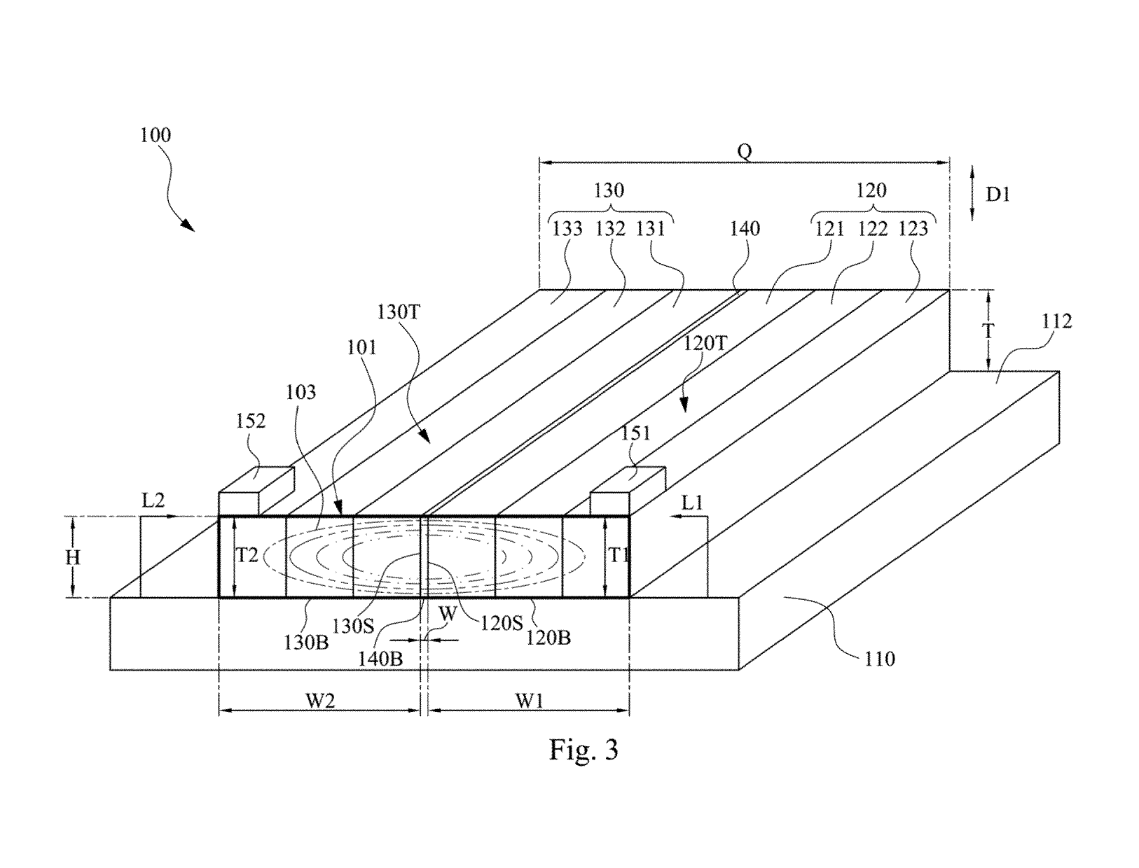

According to the founding and research described above, the inventor of the present disclosure provides various embodiments of the present disclosure to resolve the drawbacks of the light modulator 10. FIG. 3 is perspective view schematically illustrating a light modulator 100 according to various embodiments of the present disclosure. The light modulator 100 includes a substrate 110, a first semiconductor structure 120, a second semiconductor structure 130 and a dielectric structure 140. One of the technical points of the present disclosure is that the structure of the light modulator 100 is changed in which a relatively higher dopant concentration is provided in the region far away from the dielectric structure 140 to promote a relatively greater amount of free carriers to be generated at opposite sides of the dielectric structure 140; however, a relatively lower dopant concentration is provided in the region adjacent to the dielectric structure 140 to effectively reduce the hindrance to light transmission.

The substrate 110 has a principal surface 112 and a first direction D1 substantially perpendicular to the principal surface 112. In one embodiment, the substrate 110 includes a doped or undoped silicon wafer, or a semiconductor-on-insulator substrate, or other liked semiconductor materials.

The first semiconductor structure 120 is positioned over the principal surface 112, and the first semiconductor structure 120 has a first conductive type. For example, the first semiconductor structure 120 may include N-type semiconductor material or P-type semiconductor material. Illustrative examples of the first semiconductor structure 120 include N-doped or P-doped polycrystalline silicon, amorphous silicon, single crystalline silicon, or the like. The dopants, for example, may be Group 3A or Group 5A element or compounds containing Group 3A or 5A group elements, or the like.

The second semiconductor structure 130 is positioned over the principal surface 112, and the second semiconductor structure 130 has a second conductive type. It is noted that the second semiconductor structure 130 is not overlapped With the first semiconductor structure 120 in the first direction D1. In particular, when viewed in the first direction D1 (e.g., the diagram shown in FIG. 3), there exists a spacing interval between the second semiconductor structure 130 and the first semiconductor structure 120, and therefore the second semiconductor structure 130 is not overlapped with the first semiconductor structure 120. In addition, the second conductive type of the second semiconductor structure 130 is different from the first conductive type of the first semiconductor structure 120. For example, when the first semiconductor structure 120 includes N-type semiconductor material, the second semiconductor structure 130 includes P-type semiconductor material; alternatively when the first semiconductor structure 120 includes P-type semiconductor material, the second semiconductor structure 130 includes N-type semiconductor material.

The dielectric structure 140 extends upwards from the principal surface 112 of the substrate 110 along the first direction D1, and is interposed between the first semiconductor structure 120 and the second semiconductor structure 130. In some embodiments of the present disclosure, the first semiconductor structure 120 has a first sidewall 120S, and the second semiconductor structure 130 has a second sidewall 130S. In certain examples, the first sidewall 120S and the second side wall 130S extend substantially along the first direction D1, and the first sidewall 120S is opposite to the second side wall 130S. The dielectric structure 140 is interposed between the first side wall 120S of the first semiconductor structure 120 and the second side wall 130S of the second semiconductor structure 130, and therefore physically separates the first semiconductor structure 120 from the second semiconductor structure 130 such that the first semiconductor structure 120 is not in direct contact with the second semiconductor structure 130.

The dielectric structure 140 may be any suitable dielectric material such as silicon nitride, silicon oxide, doped silicon glass, or the like. The dielectric structure 140 may include a low-k dielectric material such as for example phosphorus silicate glass (PSG), boron phosphorous silica glass (BPSG), fluorine silicon glass (FSG), silicon carbide material, or a combination thereof, or the like. The dielectric structure 140 may include high-k dielectric material such as for example hafnium oxide (HfO2), hafnium silicon oxide (HfSiO), hafnium silicon oxide nitrogen (HfSiON), tantalum oxide, hafnium (HfTaO), hafnium oxide (HfTiO), hafnium, zirconium oxide (HfZrO), or the like.

In some embodiments of the present disclosure, the, dielectric structure 140 physically contacts the first semiconductor structure 120, and the contact surface (or interface) between the dielectric structure 140 and the first semiconductor structure 120 extends to the principal surface 112 of the substrate 110. In yet some embodiments, the dielectric structure 140 physically contacts the second semiconductor structure 130, and the contact surface (or interface) between the dielectric structure 140 and the second semiconductor structure 130 extends to the principal surface 112 of the substrate 110.

In some embodiments of the present disclosure, the height H of the dielectric structure 140 is greater than the width W of the dielectric structure 140. In some examples, the ratio of the height H to the width W (i.e., H/W) of the dielectric structure 140 is ranged from about 1.0 to about 50.0, such as about 1.5, about 2.0, about 3.0, about 5.0 about 10.0, about 20.0, about 30.0 and about 40.0. In some examples, the height H of dielectric structure 140 is ranged from about 0.05 μm to about 5 μm, for example about 0.1 μm, about 0.2 μm, about 0.5 μm, about 1 μm, about 2 μm or about 4 μm.

In some embodiments of the present disclosure, the first semiconductor structure 120 and the second semiconductor structure 130 respectively have a first top surface 120T and a second top surface 130T. The first top surface 120T extends laterally on a substantially identical first level L1 to a position touching the dielectric structure 140, and the second top surface 130T extends laterally on a substantially identical level L2 to a position touching the dielectric structure 140. In some examples, the first level L1 is substantially the same as the second level L2. That is, the first top surface 120T of the first semiconductor structure and the second top surface 130T of the second semiconductor structure are extended on substantially the same level.

In some embodiments of the present disclosure, the dielectric structure 140 is free from coverage on the first top surface 120T of the first semiconductor structure 120 and the second top surface 130T of the second semiconductor structure 130. Therefore, when viewed along the first direction D1, the first semiconductor structure 120, the dielectric structure 140 and the second semiconductor structure 130 are not overlapped with each other. In yet some embodiments, the first semiconductor structure 120 and the second semiconductor structure 130 do not cover the top surface of the dielectric structure 140.

In yet some embodiments, the bottom surface 140B of the dielectric structure 140, the bottom surface 120B of the first semiconductor structure 120 and the bottom surface 130B of the second semiconductor structure 130 are in direct contact with the principal surface 112 of the substrate 110.

In some embodiments of the present disclosure, when viewed along the first direction D1, the first semiconductor structure 120 and the second semiconductor structure 130 are mirror symmetric with respect to the dielectric structure 140 as a symmetry axis. In some examples, the first semiconductor structure 120 and the second semiconductor structure 130 respectively have a first width W1 and a second width W2, and the first width W1 is substantially equal to the second width W2. In yet some embodiments, in a cross-sectional structure of the light modulator 100, the first semiconductor structure 120 and second semiconductor structure 130 appear a horizontally symmetric structure with respect to the dielectric structure 140 as a symmetry axis. In some examples, the height H of the dielectric structure 140 is substantially equal to the thickness T1 of the first semiconductor structure 120 and the thickness T2 of the second semiconductor structure 130.

In some embodiments of the present disclosure, the first semiconductor structure 120, the second semiconductor structure 130 and the dielectric structure 140 of the light modulator 100 are disposed laterally on the same plane. A spatial set of the first semiconductor structure 120, the second semiconductor structure 130 and the dielectric structure 140 defines an active region 101 of the light modulator 100. Even though the light intensity distribution potentially possesses a lateral extension along the first and second semiconductor structures, the light is still confined or limited in the active region 101. Therefore, according to various embodiments of the present disclosure, light may be confined in the active region to transmit. In addition, the range of the active region 101 can be modulated by modifying the thicknesses and the widths of the first semiconductor structure 120, the second semiconductor structure 130 and the dielectric structure 140. Accordingly, the technical drawbacks that the light can not be confined in the active region associated with the light modulator 10 illustrated in FIG. 1 is effectively resolved in accordance with the embodiments of the present disclosure.

According to some embodiments of the present disclosure, the light intensity distribution 103 exhibits an eclipse-liked distribution, as shown in FIG. 3. The light transmitted in the regions adjacent to the dielectric structure 140 has a relatively higher intensity, whereas the light transmitted in the regions far away from the dielectric structure 140 has a relatively lower intensity. In some examples, light intensity distribution 103 is symmetric with respect to the dielectric structure 140 as a symmetric axis. According to various embodiments of the present disclosure, the first semiconductor structure, the second semiconductor structure, and the dielectric structure constitute an optical waveguide structure, and that structure provides a light channel or light intensity distribution which is substantially elliptical or circular.

According to yet some embodiments of the present disclosure, the first semiconductor structure 120 includes a number of doping regions such as a first doping region 121, a second doping region 122 and a third doping region 123. The dopant concentration of the first doping region 121 is less than the dopant concentration of the doping region 122, which is less than the dopant concentration of the third doping region 123. In other words, in the first semiconductor structure 120, the first doping region 121 has the minimum dopant concentration, while the third doping region 123 has a maximum dopant concentration. Similarly, the second semiconductor structure 130 may includes a number of doping regions such as a fourth doping region 131, a fifth doping region 132 and a sixth doping region 133. The dopant concentration of the fourth doping region 131 is less than the dopant concentration of the fifth doping region 132, which is less than the dopant concentration of the sixth doping region 133. In other words, in the second semiconductor structure 130, the fourth doping region 131 has a minimum dopant concentration, while the sixth doping region 133 has a maximum dopant concentration.

The maximum dopant concentrations are provided in both of the third doping region 123 and the sixth doping region 133, that are positioned far way from the dielectric structure 140, in order to generate a relatively greater amount of free carriers gathering at opposite sides of the dielectric structure 140. The minimum dopant concentrations are provided in both of the first doping region 121 and the fourth doping region 131 that are adjacent to the dielectric structure 140. These regions adjacent to the dielectric structure 140 has a relatively higher intensity of light, and the reduction of the dopant concentration in this region may effectively reduce the hindrance to light transmission. In these embodiments, different doping regions are horizontally disposed on a plane, and therefore a plurality of regions with different dopant concentrations may be easily formed by ion implanting technologies. As compared to the method that the dopant concentration gradient is constituted in the thickness direction by ion implanting approach so to form regions with different dopant concentrations, the embodiments provided in the present disclosure may achieve the effect of precise control of the concentration distribution.

According to some embodiments of the present disclosure, the summation of the first width W1 of the first semiconductor structure 120, the width W of the dielectric structure 140, and the second width W2 of the second semiconductor structure 130 defines the width Q of the light modulator 100, and the height H of the dielectric structure 140 defines the thickness T of the light modulator 100. For example, the width Q of the light modulator 100 may be about 0.2 μm to about 10 μm, and the thickness T of the light modulator 100 may be about 0.1 μm to about 5 μm.

In yet some embodiments, the light modulator 100 may further includes a first conductive contact structure 151 and a second conductive contact structure 152 respectively in contact with the first semiconductor structure 120 and the second semiconductor structure 130. In some examples, the first conductive contact structure 151 is in contact with the third doping region 123 of the first semiconductor structure 120, whereas the second conductive contact structure 152 is in contact with the sixth doping region 133 of the second semiconductor structure 130. The first conductive contact structure 151 and the second conductive contact structure 152 are configured to apply voltage signals to the first semiconductor structure 120 and the second semiconductor structure 130 such that a voltage difference is generated between the first semiconductor structure 120 and the second semiconductor structure 130.

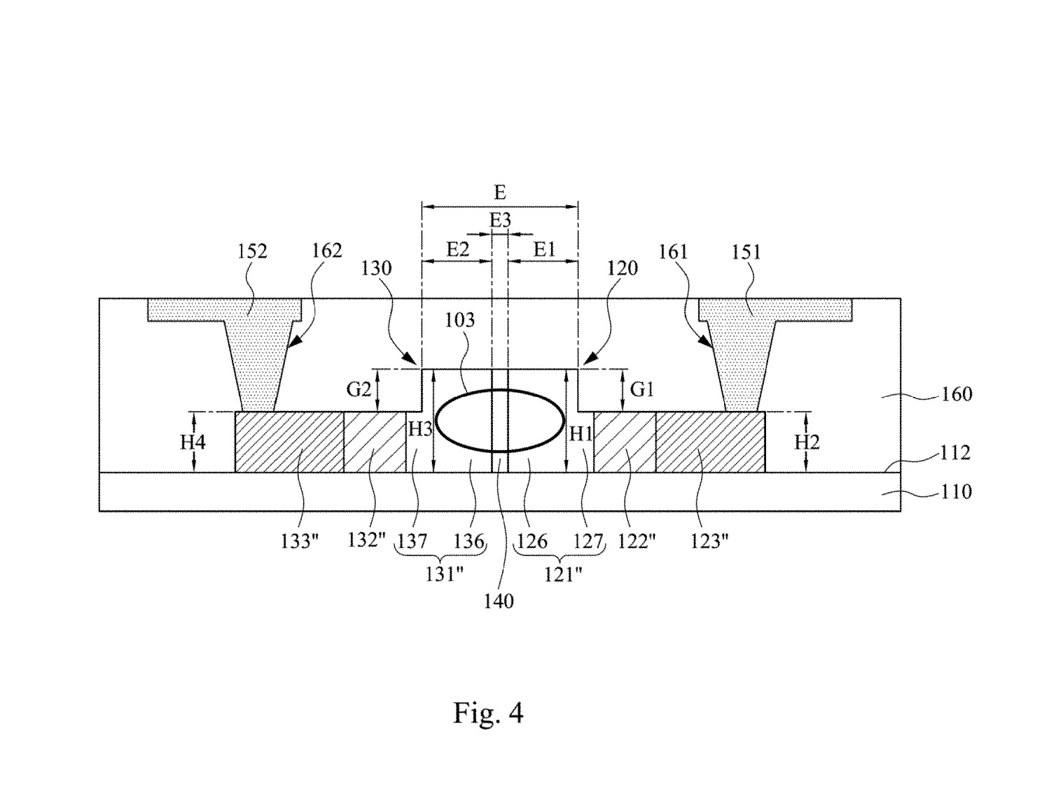

FIG. 4 is a cross-sectional view schematically illustrating a light modulator 100a according to some embodiments of the present disclosure. In FIG. 4, the same or similar features are identified by the same reference numerals. These features are the same as or similar to like-numbered features described with respect to FIG. 1. The first semiconductor structure 120 of the light modulator 100a includes a first doping portion 121″, a second doping portion 122″ and a third doping portion 123″. The dopant concentration of the first doping portion 121″ is less than the dopant concentration of the second doping portion 122″, and the dopant concentration of the second doping portion 122″ is less than that of the third doping portion 123″. Similarly, the second semiconductor structure 130 includes a fourth doping portion 131″, a fifth doping portion 132″ and a sixth doping portion 133″. The dopant concentration of the fourth doping portion 131″ is less than the dopant concentration of the fifth doping portion 132″, and the dopant concentration of the fifth doping portion 132′ is less than that of the six doping portion 133″. One of the features of the light modulator 100a is that first doping portion 121″ has a height that is greater than a height H2 of the second doping portion 122″, and the fourth doping portion 131″ has a height H3 that is greater than a height H4 of the fifth doping portion 132″.

In one embodiments, the first doping portion 121″ includes a standing portion 126 and an extending portion 127. The standing portion 126 is in contact with the dielectric structure 140, and the extending portion 127 extends laterally from the standing portion 126 to the second doping portion 122′. A height H1 of the standing portion 126 is greater than a height H2 of the extending portion 127. In some examples, the standing portion 126 and the dielectric structure 140 have substantially the same height H1, while the extending portion 127, the second doping portion 122″, and the third doping portion 123″ have substantially the same height H2. For example, the height H1 may be about 150 nm to about 300 nm, and the height H2 may be about 50 nm to about 130 nm. In some examples, a height difference G1 between a top surface of the first doping portion 121″ and a top surface of the second doping portion 122″ is about 50% to about 70% of the height H1.

Similarly, the fourth doping portion 131″ includes a standing portion 136 and an extending portion 137. The standing portion 136 is in contact with the dielectric structure 140, and the extending portion 137 extends laterally from the standing portion 136 to the fifth doping portion 132″. A height H3 of the standing portion 136 is greater than a height H4 of the extending portion 137. In some examples, the standing portion 136 and the dielectric structure 140 have substantially the same height H3, and the extending portion 137, the fifth doping portion 132″, and the sixth doping portion 133″ have substantially the same height H4. For example, the height H3 may be about 150 nm to about 300 nm, and the height H4 maybe about 50 nm to about 130 nm. In some examples, a height difference G2 between a top surface of the fourth doping portion 131″ and a top surface of the fifth doping portion 132″ is about 50% to about 70% of the height H3. In one specific example, the height H1 is substantially equal to the height H3, and the height H2 is substantially equal to the height H4.

The standing portion 126, the standing portion 136 and the dielectric structure 140 collectively constitute a rib waveguide of the light modulator 100a. In some examples, the total width E in sum of the width E1 of the standing portion 126, the width E2 of the standing portion 136, and the width E3 of the dielectric structure 140 is about 1.5 folds to about 2.5 folds of the height H1 of the standing portion 126 (or the height H3 of the standing portion 136). The total width E, for example, may be about 400 nm to about 550 nm, preferably about 410 nm to about 430 nm.

According to some embodiments of the present disclosure, the standing portion 126 and the standing portion 136 may confine or alter the light intensity distribution 103 in the light modulator 100a. As shown in FIG. 4, the light intensity distribution 103 in the light modulator 100a may be effectively concentrated or limited in the range of the total width E by the standing portion 126 and the standing portion 136. In addition, the heights H1, H3 of the standing portions 126, 136 affect the light intensity distribution 103 as well. By altering the heights H1, H3 of the standing portions 126, 136, a circle-liked light intensity distribution 103 may be obtained. Therefore, according to some embodiments of the present disclosure, the features of the widths and/or the heights of the standing portions and certain ratios provided herein contribute to certain technical effects, and are not simple design changes or simple modifications.

The light modulator 100a may optionally include a dielectric layer 160, a first conductive contact structure 151 and a second conductive contact structure 152. The dielectric layer 160 is positioned over the first semiconductor structure 120, the second semiconductor structure 130 and the dielectric structure 140. The dielectric layer 160 has a first opening 161 and a second opening 162 respectively aligned with the third doping portion 123″ and the sixth doping portion 133″. The first conductive contact structure 151 and the second conductive contact structure 152 are electrically connected to the third doping portion 123″ and the sixth doping portion 133″ respectively through the first opening 161 and the second opening 162.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims and their equivalents.

What is claimed is:

1. A light modulator, comprising:
a substrate having a principal surface and a first direction substantially perpendicular to the principal surface;
a first semiconductor structure, having a first conductive type, positioned over the principal surface;
a second semiconductor structure, having a second conductive type, positioned over the principal surface, wherein the first semiconductor structure is free from overlapping the second semiconductor structure in the first direction; and
a dielectric structure positioned over the principal surface and extending upwards along the first direction from the principal surface, the dielectric structure being interposed between the first semiconductor structure and the second semiconductor structure;
wherein the first semiconductor structure, the second semiconductor structure, and the dielectric structure constitute an optical waveguide for providing a substantially elliptical or circular light channel.

2. The light modulator according to claim 1, wherein the first semiconductor structure and the second semiconductor structure respectively have a first top surface and a second top surface, and the first top surface and the second top surface are not covered by the dielectric structure.

3. The light modulator according to claim 2, wherein the first top surface of the first semiconductor structure laterally extends on a substantially identical first level to a position touching the dielectric structure.

4. The light modulator according to claim 3, wherein the second top surface of the second semiconductor structure extends on a substantially identical second level to a position touching the dielectric structure.

5. The light modulator according to claim 4, wherein the first level is substantially the same as the second level.

6. The light modulator according to claim 1, wherein the dielectric structure separates the first semiconductor structure from the second semiconductor structure such that the first semiconductor structure is not in direct contact with the second semiconductor structure.

7. The light modulator according to claim 1, wherein the dielectric structure has a width and a height that is greater than the width.

8. The light modulator according to claim 7, wherein the height of the dielectric structure is substantially equal to a thickness of the first semiconductor structure and a thickness of the second semiconductor structure.

9. The light modulator according to claim 1, wherein the first semiconductor structure and the second semiconductor structure respectively have a first width and a second width, and the first width is substantially equal to the second width.

10. The light modulator according to claim 1, wherein the first semiconductor structure comprises a first doping portion and a second doping portion, the first doping portion being in contact with the dielectric structure and located between the dielectric structure and the second doping portion, wherein a doping concentration of the first doping portion is less than a doping concentration of the second doping portion.

11. The light modulator according to claim 10, wherein a height of the first doping portion is greater than a height of the second doping portion.

12. The light modulator according to claim 10, wherein the first doping portion comprises a standing portion and an extending portion, the standing portion being in contact with the dielectric structure, wherein the extending portion laterally extends from the standing portion to the second doping portion, and a height of the standing portion is greater than a height of the extending portion.

13. The light modulator according to claim 12, wherein the height of the standing portion substantially equals a height of the dielectric structure, and the height of the extending portion substantially equals a height of the second doping portion.

14. The light modulator according to claim 10, wherein the second semiconductor structure comprises a fourth doping portion and a fifth doping portion, the fourth doping portion being in contact with the dielectric structure and positioned between the dielectric structure and the fifth doping portion, wherein a doping concentration of the fourth doping portion is less than a doping concentration of the fifth doping portion.

15. The light modulator according to claim 14, wherein a height of the fourth doping portion is greater than a height of the fifth doping portion.

16. The light modulator according to claim 14, wherein the fourth doping portion comprises a standing portion and an extending portion, the standing portion being in contact with the dielectric structure, wherein the extending portion laterally extends from the standing portion to the fifth doping portion, and a height of the standing portion is greater than a height of the extending portion.

17. The light modulator according to claim 16, wherein the height of the standing portion substantially equals a height of the dielectric structure, and the height of the extending portion substantially equals a height of the fifth doping portion.
